(19) United States
(12) Patent Application Publication
(10) Pub. No.: US 2015/0009154 A1
(43) Pub. Date: Jan. 8, 2015

(54) ELECTRONIC DEVICE AND TOUCH CONTROL METHOD THEREOF

(71) Applicant: Acer Incorporated, New Taipei City (TW)

(72) Inventors: Chun-Yi Shih, New Taipei City (TW); Yi-Wen Liu, New Taipei City (TW)

(73) Assignee: Acer Incorporated, New Taipei City (TW)

(21) Appl. No.: 14/061,761

(22) Filed: Oct. 24, 2013

(30) Foreign Application Priority Data
Jul. 8, 2013 (TW) 102124434

(51) Int. Cl. G06F 3/0488; G06F 3/0354; G06F 3/041

(52) U.S. Cl. CPC G06F 3/04883; G06F 3/041; G06F 3/03545
USPC 345/173

(57) ABSTRACT

An electronic device, adapted for interacting with a stylus, wherein the stylus transmits a control signal to the electronic device, is provided. The electronic device includes a touch screen, a communicating unit and a processing unit. The touch screen receives a touch action made by the stylus. The communicating unit receives the control signal transmitted by the stylus. The processing unit is coupled to the touch screen and the communicating unit, receives the touch action and the control signal. The processing unit determines a touch gesture corresponding to a touch action according to the touch action, and determines an operating state of the stylus according to the control signal. Also, the processing unit executes a corresponding action according to the touch gesture, the operating state and/or an application program which is currently executed by the electronic device.

### CROSS-REFERENCE TO RELATED APPLICATION

This application claims the priority benefit of Taiwan application serial no. 102124434, filed on Jul. 8, 2013. The entirety of the above-mentioned patent application is hereby incorporated by reference herein and made a part of this specification.

### BACKGROUND OF THE INVENTION

1. Field of the Invention

The invention relates to an electronic device, more particularly to an electronic device and a touch control method thereof.

2. Description of Related Art

With instant advance in science and technologies, the calculation capability of mobile electronic devices such as smart phones and tablet PCs has been continuously improved. Basically, the calculation capability of current mobile electronic devices is able to fulfill users' needs, such as taking photos, taking notes, surfing the Net, and so on. Still, there are some inconveniences when it comes to using. For example, it is likely that the user usually spends too much time searching for needed software in a menu. In the case where the user comes across some information that interests the user when walking on the street or in a vehicle and would like to record the information immediately via a note-taking software or the photo-taking function of a mobile electronic device, before that is done, the user may need to take steps such as unlocking the screen, searching for the needed software and clicking on the software in the user's interface on a touch screen, and waiting for the software to be started, etc.

Currently, several approaches are available for simplifying the above steps with the help of known techniques. For example, the user may arrange frequently used functions in shortcuts or a toolbar on the desktop of the touch screen so that the user can find the needed software more intuitionally. In fact, such configuration does not solve the problem but merely allows the user to find the needed software faster. Meanwhile, not too much software can be arranged in the shortcuts and the tool bar in case the user still needs to spend a lot of time to search for the needed one.

In another approach to finding the needed software, a physical button is used to be directly configured on the electronic device. For example, when the user presses the physical button, a corresponding software is directly started. Such configuration is commonly used for a camera function. After the function is started, the same physical button may also serve as a shutter button. Although such approach is the most intuitive and the fastest, based on the logic of current design of a mobile electronic device, it is impossible for too many physical buttons to be configured in the mobile electronic device. Furthermore, most manufacturers of the mobile electronic device do not make it available for the user to define functions for corresponding physical buttons, in which case, the user still cannot set the software that is to be instantly started.

### SUMMARY OF THE INVENTION

The invention provides an electronic device and a touch control method thereof, through which the gestures of a user for operating a stylus and an operating method are received to instantly start the programs in the electronic device or to execute corresponding operations.

In the invention, an electronic device is adaptable for interacting with a stylus, wherein the stylus transmits a control signal to the electronic device. The electronic device includes a touch screen, a communicating unit, and a processing unit. The touch screen receives the touch action of the stylus. The communicating unit receives the control signal transmitted by the stylus. The processing unit is coupled to the touch screen and the communicating unit to receive the touch action and the control signal, wherein the processing unit determines a touch gesture corresponding to the touch action according to the touch action. The processing unit determines an operating state of the stylus according to the control signal. Meanwhile, the processing unit executes a corresponding action according to the touch gesture, the operating state and/or an application program currently executed by the electronic device.

In the invention, a touch control method is adaptable for an electronic device having a touch screen and interacting with a stylus, wherein the stylus returns a control signal to the electronic device. The method includes the following steps, firstly, receiving a touch action of the stylus from the touch screen; then, determining a touch gesture corresponding to the touch action according to the touch action; determining an operating state of the stylus according to the control signal transmitted by the stylus; thereafter, executing a corresponding action according to the touch gesture, operating state, and/or a currently executed application program.

According to the above, the invention provides an electronic device and a touch control method thereof, which determine a corresponding touch gesture according to a touch action of a stylus performed on a touch screen of the electronic device and instantly execute a corresponding action according to the touch gesture and a current state of the stylus.

In order to make the aforementioned features and advantages of the invention more comprehensible, embodiments accompanying figures are described in detail below.

### BRIEF DESCRIPTION OF THE DRAWINGS

FIG. 1 is a block diagram of an electronic device illustrated according to an embodiment of the invention.

FIG. 2 is a schematic view illustrating relations between an electronic device illustrated according to an embodiment of the invention and a stylus and different corresponding actions.

FIGS. 3A-3C are schematic views illustrating that a corresponding action illustrated according to an embodiment of the invention is a specific mode which corresponds to different operating actions.

FIGS. 4A-4B are schematic views illustrating implementation in which a corresponding action illustrated according to an embodiment of the invention is a specific mode.

FIG. 5 is a schematic view illustrating implementation in which a corresponding action illustrated according to an embodiment of the invention is a specific mode.

FIG. 6 is a flow chart illustrating a touch control method illustrated according to an embodiment of the invention.

### DESCRIPTION OF EMBODIMENTS

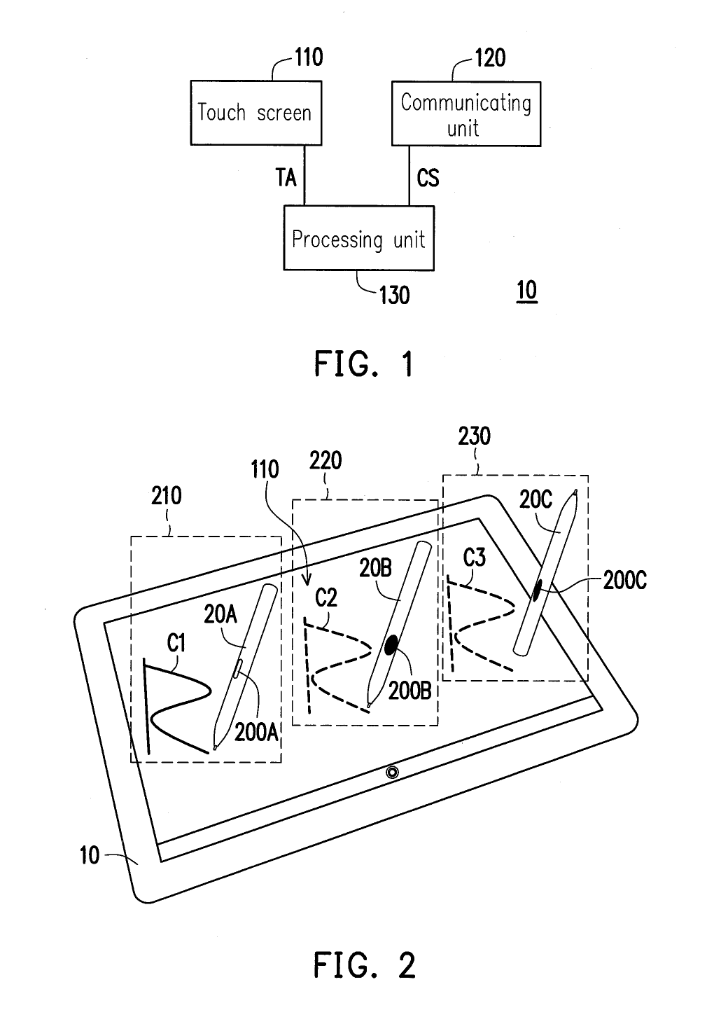

FIG. 1 is a block diagram of an electronic device illustrated according to an embodiment of the invention, wherein the electronic device is adaptable for interacting with a stylus. Moreover, the stylus transmits a control signal to the electronic device. Please refer to FIG. 1. An electronic device 10 includes a touch screen 110, a communicating unit 120, and a processing unit 130. The touch screen 110 receives a touch action TA of the stylus performed on the touch screen 110. The communicating unit 120 receives a control signal CS transmitted by the stylus. The processing unit 130 is coupled to the touch screen 110 and the communicating unit 120 for receiving the touch action TA and the control signal CS, wherein the processing unit 130 determines a touch gesture corresponding to the touch action TA according to the touch action TA. The processing unit 130 determines an operating state of the stylus according to the control signal CS. Moreover, the processing unit 130 executes a corresponding action according to the touch gesture, operating state and/or an application program currently executed by the electronic device.

In the invention, the electronic device 10 may be any electronic devices having a touch screen and calculating capability such as a smart phone, a tablet PC, a notebook computer having a touch screen and so on. Meanwhile, the stylus may be any active or passive stylus and also have a capability of returning or transmitting the control signal CS to the electronic device 10. In an embodiment of the invention, the stylus has a physical button and an orientation angle determiner (such as a gyroscope, an accelerometer, a magnetometer, or a combination thereof). In the embodiment, the control signal CS transmitted by the stylus includes a state message and a control message, wherein the state message corresponds to a current using angle of the stylus (for example, a normal using angle, a reversed using angle, or a more precisely demarcated angle). The control message corresponds to whether the physical button of the stylus is pressed or not. When receiving the control signal CS, the processing unit 130 of the electronic device 10 further determines the operating state of the stylus according to the state message and the control message.

Briefly, in the invention, the processing unit 130 of the electronic device 10 may use at least the state message (corresponding to a current included angle between the stylus and the electronic device or a current orientation of the stylus) and the control message (whether the physical button on the stylus is pressed or not) to determine a corresponding action corresponding to the touch action currently received by the electronic device 10 to execute the corresponding action. The aforementioned conditions may be set and applied differently depending on actual implementations. The invention provides no limitation to that the corresponding action corresponding to the touch action is exclusively determined by each of the conditions set forth.

In an embodiment of the invention, the corresponding action may be divided into the following modes: a general input mode, an instant start mode, a specific mode, and a setting mode. Each of the modes corresponds to a combination of different touch gestures, control signals and/or currently executed application programs.

When the corresponding action is the general input mode, the processing unit 130 receives the touch action from the touch screen 110 as a touch input. The touch input includes a general clicking on the touch screen 110 or an input trajectory. For example, the trajectory of the touch input may be displayed directly on the touch screen 110, and the trajectory may serve as a handwritten note or an image of drawing inputted by the user. Alternatively, the processing unit 130 may also analyze the aforementioned touch input and convert the trajectory of the touch input into text to be displayed on the touch screen 110.

When the corresponding action is the instant start mode, the processing unit 130 instantly starts an application program in the electronic device 10 according to the touch action and the operating state of the stylus. For example, in an embodiment of the invention, the operating state of the stylus is in the normal using state and the physical button is being pressed. Then the processing unit 130 determines that the corresponding action is the instant start mode, and further determines a touch gesture corresponding to the touch action inputted by the stylus so as to instantly start the application program corresponding to the touch gesture.

It should be noted that normally the instant start mode may be set as a global corresponding action. That is, no matter what application program is currently being executed by the electronic device 10, when the user inputs the touch action corresponding to the touch gesture using the stylus, a corresponding application program (different from the currently executed application program) can be instantly started, and a user interface of the corresponding application program can be switched to be displayed on the touch screen 110. The touch gesture and the corresponding application program may be pre-stored in a memory (not shown) in the processing unit 130 or may be set by the user.

For example, when the corresponding action is the setting mode, the processing unit 130 sets an operating gesture corresponding to the program currently executed by the electronic device 10 according to the touch action and the operating state. In an embodiment of the invention, when executing a specific application program (for example, a setting program of touch gestures) and completing other settings (such as the instant start mode setting, or the touch gesture in other modes, or instantly started application program corresponding to the touch gesture, etc.), the processing unit 130 determines that the corresponding action is the setting mode. Furthermore, in the embodiment, when the operating state of the stylus is in a specific state (for example, the stylus is in a predetermined angle and the button is being pressed), the processing unit 130 determines that the corresponding action is the setting mode. When the user inputs the touch action using the stylus, the processing unit 130 records the touch action as the touch gesture that corresponds to the application program currently executed by the electronic device 10.

For example, assume that the application program of the electronic device 10 currently used by the user is a note-taking software. When the user reverses the stylus to form a predetermined angle, presses the button on the stylus, and draws an “R” shaped trajectory (i.e. touch action) on the touch screen 110, the processing unit 130 makes the “R” shaped trajectory as a touch gesture corresponding to the note-taking software. Thereafter, whenever the user presses the button on the stylus in the normal using angle (allowing the processing unit 130 to determine the corresponding action to be the instant start mode) and draws the “R” shaped trajectory on the touch screen 110, the processing unit 130 instantly starts the corresponding application program, that is, the note-taking software. In the embodiment, when the user wants to modify or delete the aforementioned touch gestures, the user can control the electronic device 10 to execute the touch gesture setting program so as to modify or delete the action of the touch gesture.

FIG. 2 is a schematic view illustrating relations between an electronic device illustrated according to an embodiment of the invention and a stylus and different corresponding actions. For ease of explanation, in the embodiment, the electronic device 10 is set to be a tablet PC. Please refer to FIG. 2. In an implementation method 210, the user uses a stylus 20A in a normal using angle without pressing a button 200A on the stylus 20A. At the moment, the processing unit 130 determines that the corresponding action is the general input mode. The “R” shaped trajectory (touch action) inputted on the touch screen 110 by the user via operating the stylus 20A is set as the touch input by the processing unit 130. When corresponding to different application programs, the trajectory may serve as images, handwritten notes, or may be converted into text.

In an implementation method 220, the user uses a stylus 20B in the normal using angle and presses a button 200B on the stylus 20B. At the moment, the processing unit 130 determines that the corresponding action is the instant start mode. The “R” shaped trajectory (touch action) inputted on the touch screen 110 by the user via operating the stylus 20A is used by the processing unit 130 to determine whether there is a corresponding touch gesture. In the embodiment, it is stored in the memory of the processing unit 130 that the “R” shaped trajectory is similar to the touch gesture corresponding to an application program (such as the note-taking software). Therefore, the processing unit 130 determines that the user inputs the touch gesture corresponding to the application program; then, the processing unit 130 instantly starts the application program (such as the note-taking software).

In an implementation method 230, the user uses a stylus 20C in a predetermined using angle and presses a button 200C on the stylus 20C. At the moment, the processing unit 130 determines that the corresponding action is the setting mode. The “R” shaped trajectory (touch action) inputted on the touch screen 110 by the user via operating the stylus 20C is set by the processing unit 130 to be the touch gesture corresponding to the currently executed application program. Please refer to the description regarding the setting mode for a detailed setting method; no further description is incorporated herein.

Apart from the aforementioned modes, in the invention, the mode of corresponding actions and the content of the actions may be set via any combination of different touch actions, control signals, and currently executed application programs. For example, in the implementation method 230, the user uses the stylus 20C in the predetermined using angle without pressing the button 200C on the stylus 20C. At the moment, the processing unit 130 determines that the corresponding action is a recording mode; the touch action performed by the user via the stylus 20C serves as a touch input, and an application program in the electronic device 10 having a recording function is started for recording at the same time. Each mode of the corresponding actions may be preset in the electronic device 10 (such as storing the conditions for determining the corresponding action to be each mode in the memory of the processing unit 130); alternatively, the modes may be added or modified by the user depending on needs. The relation between the combination of the touch actions, control signals, and/or currently executed application programs and each mode of the corresponding actions may also be preset in the electronic device 10 or added/modified by the user. The invention provides no limitation to the implementation methods described above.

On the other hand, when the corresponding action is the specific mode, the processing unit 130 determines an operating action corresponding to the touch action and operating state in response to a display content displayed on the touch screen by the program currently executed by the electronic device. Relative to the aforementioned general input mode or instant start mode, the specific mode is normally set as a local corresponding action, that is to say, which is used only for a specific application program or under a specific using circumstance. In other words, in the case where the corresponding action is the specific mode, when the same touch gesture corresponds to different application programs, different functions and effects may be generated. The implementation method in which the corresponding action is the specific mode is described below with embodiments accompanying figures.

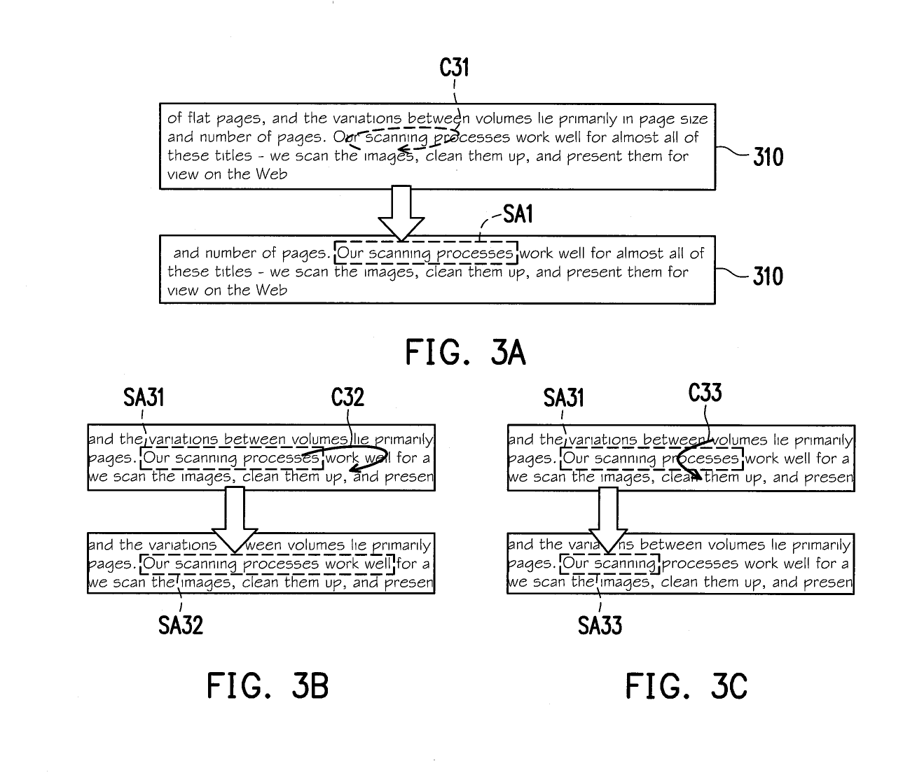

FIGS. 3A-3C are schematic views illustrating that a corresponding action illustrated according to an embodiment of the invention is a specific mode which corresponds to different operating actions. Please refer to FIG. 3A. In the embodiment, the electronic device is executing an application program used for word processing, such as a note-taking software. A display content 310 on the touch screen 110 includes a text content. At the moment, when the user uses the stylus in the normal using angle, presses the button on the stylus, and draws a trajectory C31 (touch action) in the text content, the processing unit 130 determines that the corresponding action is the specific mode according to the currently executed application program (note-taking software). According to the trajectory C31 (a clock-wise trajectory above the text content), the processing unit 130 determines that the touch action corresponds to an operating action to be the touch gesture of selecting the text content in the trajectory C31, and selects the text content in the trajectory C31 to be served as a selected range SA1. Since the user may not be able to operate the stylus in a very accurate state, in the embodiment, the processing unit 130 not only selects the text content in the trajectory C31, but also analyzes whether the text content in the trajectory C31 and the contexts front and rear have relevance (such as determining by meaning or part of speech), thereby automatically adjusting the range of the selected range according to the relevance. For example, when the text content in the selected range is relevant to the subsequent word, the processing unit automatically selects the subsequent word to be in the selected range (such as the selected range SA1). As shown in FIG. 3A, in the trajectory C31, only half of the word “Our” and a part of the word “process” are circled, at the moment, the processing unit 130 makes determination according to the relevance. Since both words are relevant to the word “scanning”, “Our” and “process” are both selected to be in the selected range SA1.

Also, the user may keep adjusting the selected range via the touch action under the specific mode. As shown in FIG. 3B, the display content 310 already has a selected range SA31 (such as selected by the trajectory C31 in FIG. 3A). Then, when the user draws a trajectory C32 on the touch screen via the stylus (a clock-wise trajectory above the word adjacent to the selected range), the processing unit 130 broadens selected range according to the trajectory C32 (i.e. touch action), the corresponding touch gesture (clock-wise trajectory), and a current operating state of the stylus (normal using angle, pressing the button) such that the selected range SA31 is broadened to a selected range SA32.

FIG. 3C shows the opposite of what is shown in FIG. 3B. The user draws a trajectory C33 (a counter-clockwise trajectory above the selected range) on the touch screen via the stylus, the processing unit 130 reduces the selected range SA31 to a selected range SA33 according to the trajectory C33 (i.e. touch action), the corresponding touch gesture (counter-clockwise trajectory), and the current operating state of the stylus (normal using angle, pressing the button).

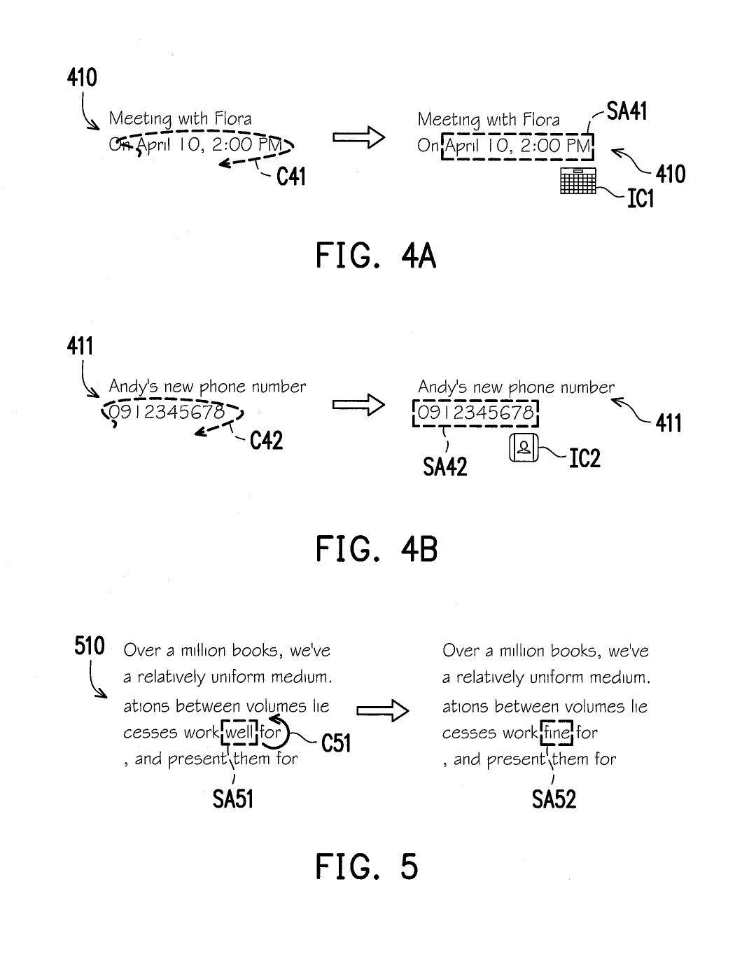

FIGS. 4A-4B are schematic views illustrating that a corresponding action illustrated according to an embodiment of the invention is a specific mode. Please refer to FIG. 4A. Similar to FIG. 4A, the user uses the stylus to generate the touch action to draw a trajectory C41 to select a part of the text content in a display content 410 to be a selected range SA41. In the embodiment shown in FIG. 4A, the processing unit 130 further analyzes the text content in the selected range SA41. When the text content matches a preset format of an application program, the processing unit 130 displays an instant start button of the application program near the selected range (such as selected range SA41) on the touch screen 110. For example, in FIG. 4A, the text content in the selected range SA41 is date and/or time, after analyzing the content, the processing unit 130 determines that the aforementioned text content matches a preset format of a calendar (application program). Therefore, the processing unit 130 displays an instant start button IC1 of the calendar adjacent to the selected range SA41. When the user clicks (such as clicking in the general input mode) on the instant start button IC1, the processing unit 130 instantly starts the calendar and transmits the text content in the selected range SA41 to the calendar so that the calendar can directly display corresponding content when it is executed again, such as directly displaying a blank column of the calendar of the date/time for the user to input corresponding content, or automatically filling in the blank columns of the calendar with corresponding content (such as the text content preceding and following the selected range) for the user's confirmation.

Likewise, in the embodiment shown in FIG. 4B, the user uses the stylus to generate the touch action to draw a trajectory C42 to select a part of the text content in a display content 411 to be a selected range SA42. After analyzing the text content in the selected range SA42, the processing unit 130 determines that the text content in the selected range SA42 matches a telephone number format, and therefore the processing unit 130 displays an instant start button IC2 of a telephone directory adjacent to the selected range SA42. After the user clicks on the instant start button IC2 of the telephone directory, the processing unit 130 can instantly start the telephone directory and transmit the text content (i.e. telephone numbers) in the selected range to the telephone directory. It should be noted that the aforementioned instant start buttons IC1 and IC2 may disappear when the user cancels the selected range, or may stay constantly adjacent to the selected range after being displayed. In an embodiment of the invention, when the user confirms completing a setting or saving a file (such as filling in agenda in the calendar, or adding the telephone numbers of a new contact) in the instantly started application program via the instant start button (such as the instant start buttons IC1 and IC2), the instant start button stays constantly adjacent to the selected range to provide the user with an instant access to the corresponding application program when the user reviews the text content in the future. If it is not confirmed, then the instant start button will disappear after the selected range is cancelled.

Further to the embodiments in FIGS. 3A-3C and FIGS. 4A-4B, the user may also execute an editing function to the content of text content 510 via the aforementioned touch gesture. FIG. 5 is a schematic view illustrating that a corresponding action illustrated according to an embodiment of the invention is a specific mode. Please refer to FIG. 5. For example, in the case where the user would like to modify the text content in a selected range SA51, the user further performs a touch action (i.e. drawing a trajectory C51) on the touch screen 110 in the normal using angle and the button is pressed. Then, the processing unit 130 recovers the text content in the selected range SA51 to be the text content before editing (as shown in a selected range SA52).

Such editing function may be modified according to actual situations and the user's preference. For example, the editing actions performed to the text in the selected range (such as in the selected range SA51) may include deleting, cutting, copying, pasting, and so on under different using states via different touch gestures. A connection between such using states as well as touch gestures and the user's general experiences may be established during setting. For example, the stylus may slide on the text content in the reversed using angle to delete corresponding text content. Such configuration is similar to the user's experience of using a pencil and an eraser in daily life, which allows the user to master the using method more quickly and improves the user's experiences. In the embodiments shown in FIGS. 3A-3C, FIGS. 4A-4B, and FIG. 5, all the applications programs are word-processing related application programs; in addition, the embodiments exemplify the using condition where the corresponding action is the specific mode. Such teaching provides is not limited to performing editing to text only; persons having ordinary skill in the art may also adopt the aforementioned taught concept when using different types of application programs.

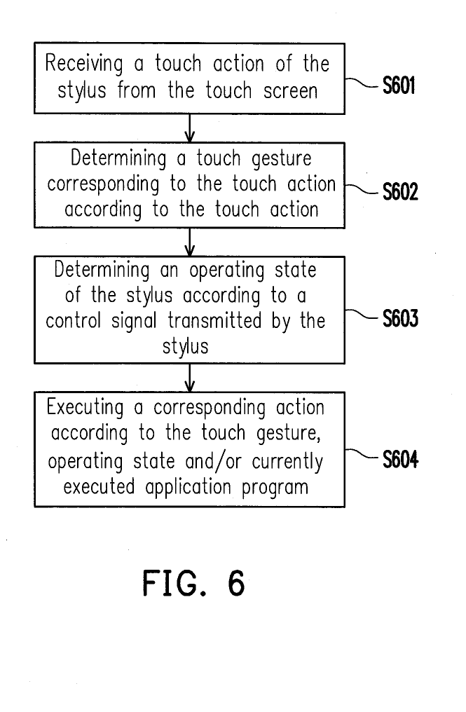

The invention provides a touch control method which is adaptable for an electronic device having a touch screen and interacting with a stylus, wherein the stylus returns or transmits a control signal to the electronic device. FIG. 6 is a flow chart showing a touch control method illustrated according to an embodiment of the invention. Please refer to FIG. 6. First of all, in step S601, a touch action of the stylus is received by the touch screen. Subsequently, in step S602, a touch gesture corresponding to the touch action is determined. Thereafter, in step S603, an operating state of the stylus is determined according to the control signal transmitted by the stylus. Then, in step S604, a corresponding action is executed according to the touch gesture, operating state and/or currently executed application programs. Regarding a detailed manner for carrying out the touch control method and details of implementation of the method, please refer to the embodiments shown in FIGS. 1-5 for description. No further description is incorporated herein.

To sum up, the invention provides an electronic device and a touch control method thereof, which allows a user to instantly start an application program to be used through an interaction between the electronic device and an external stylus, such as the using state of the stylus along with a touch action of the stylus performed on the touch screen of the electronic device. Moreover, when a specific program is in use, the using state along with the touch action of the stylus performed on the touch screen of the electronic device may also be adopted to instantly operate a displayed content.

Although the invention has been disclosed by the above embodiments, the embodiments are not intended to limit the invention. It will be apparent to those skilled in the art that various modifications and variations can be made to the structure of the invention without departing from the scope or spirit of the invention. Therefore, the protecting range of the invention falls in the appended claims.

What is claimed is:

1. An electronic device, adaptable for interacting with a stylus, wherein the stylus transmits a control signal to the electronic device, comprising:
a touch screen, receiving a touch action of the stylus;
a communicating unit, receiving the control signal transmitted by the stylus; and
a processing unit, coupled to the touch screen and the communicating unit, receiving the touch action and the control signal;
wherein the processing unit determines a touch gesture corresponding to the touch action according to the touch action;
the processing unit determines an operating state of the stylus according to the control signal;
the processing unit executes a corresponding action according to the touch gesture, the operating state, and/or a first application program currently executed by the electronic device.

2. The electronic device according to claim 1, wherein the control signal comprises a state message corresponding to a using angle of the stylus and a control message corresponding to a button of the stylus, the processing unit further determines the operating state of the stylus according to the state message and the control message.

3. The electronic device according to claim 1, wherein:
the corresponding action comprises a specific mode, when the corresponding action is the specific mode, the processing unit determines an operating action corresponding to the touch action and the operating state in response to a display content displayed on the touch screen of the first application program currently executed by the electronic device.

4. The electronic device according to claim 3, wherein:
when the displayed content comprises text content, the operating action comprises selecting a portion of the text content to be a selected range.

5. The electronic device according to claim 4, wherein:
when the operating action is selecting the portion of the text content to be the selected range, the processing unit automatically adjusts the selected range according to the text content.

6. The electronic device according to claim 4, wherein:
when the display content on the touch screen already has a selected range and the corresponding action is a specific mode, the processing unit recovers or deletes the text content in the selected range according to the touch gesture corresponding to the touch action and the operating state.

7. A touch control method, adaptable for an electronic device having a touch screen and interacting with a stylus, wherein the stylus transmits a control signal to the electronic device, comprising the following steps:
receiving a touch action of the stylus from the touch screen;
determining a touch gesture corresponding to the touch action according to the touch action;
determining an operating state of the stylus according to the control signal transmitted by the stylus; and
executing a corresponding action according to the touch gesture, the operating state and/or a first application program currently executed by the electronic device.

8. The touch control method according to claim 7, wherein the control signal comprises a state message corresponding to a using angle of the stylus and a control message corresponding to a button of the stylus, and the step of determining the operating state of the stylus according to the control signal transmitted by the stylus comprises:
determining the operating state of the stylus according to the state message and the control message.

9. The touch control method according to claim 7, wherein:
the corresponding action comprises a specific mode, when the corresponding action is the specific mode, determining an operating action corresponding to the touch gesture and the operating state in response to a display content displayed on the touch screen of the first application program currently executed by the electronic device.

10. The touch control method according to claim 9, wherein:
when the display content comprises text content, the operating action comprises selecting a portion of the text content to be a selected range.

11. The touch control method according to claim 10, wherein:
when the operating action is selecting the portion of the text content to be the selected range, the step of executing the operating action further comprises:
automatically adjusting the selected range according to the text content.
